(19) United States
(12) Patent Application Publication
(10) Pub. No.: US 2024/0280467 A1
(43) Pub. Date: Aug. 22, 2024

(54) Data Generation Method, Trained Model Generation Method, and Particle Classification Method

(71) Applicants: ThinkCyte K.K., Tokyo (JP); The University of Tokyo, Tokyo (JP)

(72) Inventors: Hiroaki Adachi, Tokyo (JP); Sadao Ota, Tokyo (JP)

(21) Appl. No.: 18/571,582

(22) PCT Filed: Jun. 17, 2022
(86) PCT No.: PCT/JP2022/024285

§ 371 Date: Dec. 18, 2023

(30) Foreign Application Priority Data
Jul. 9, 2021 (JP) 2021-114377

(51) Int. Cl. G01N 15/1433; G01N 15/149; G06V 10/764

(52) U.S. Cl. CPC G01N 15/1433; G01N 15/149; G06V 10/764

(57) ABSTRACT

First waveform data, which indicates the morphological characteristics of a particle and is obtained by emitting light to the particle, and a photographic image obtained by photographing the particle are acquired. A first trained model that outputs a particle image when waveform data is input is generated by training using first training data including the first waveform data and the photographic image. Second waveform data is input to the first trained model. Classification information indicating a classification into which the particle is classified according to the morphological characteristics is acquired in association with the particle image output from the first trained model. Data including the second waveform data and the classification information is stored as second training data for training a second trained model that outputs classification information when waveform data is input.

### CROSS-REFERENCE TO RELATED APPLICATIONS

This application is the national phase under 35 U. S. C. § 371 of PCT International Application No. PCT/JP2022/024285 which has an International filing date of Jun. 17, 2022 and designated the United States of America.

### FIELD

The present invention relates to a data generation method, a trained model generation method, a trained model, a particle classification method, a computer program, and an information processing device for classifying particles such as cells.

### BACKGROUND

Conventionally, a flow cytometry method has been used as a method for examining individual cells. The flow cytometry method is a cell analysis method for acquiring information regarding cells irradiated with light as a photographic image or the like by making cells dispersed in a fluid pass through a channel, emitting light to each cell moving through the channel, and measuring scattered light or fluorescence from the cells irradiated with light. By using the flow cytometry method, individual analysis of a large number of cells can be performed at high speed.

In addition, in the flow cytometry method, a ghost cytometry method (hereinafter, referred to as GC method) has been developed in which cells are irradiated with special structured illumination light, waveform data of the optical signal including compressed morphological information of the cells is acquired from the cells, and the cells are classified based on the waveform data. An example of the GC method is disclosed in WO2017/073737. In the GC method, a classification model for classifying cells is created in advance by machine learning from waveform data acquired from cells contained in a training sample, and cells contained in a test sample are classified by using the classification model. Due to the GC method, more accurate and faster cell analysis becomes possible.

### SUMMARY

In order to create a classification model with high identification accuracy by using the GC method, it is necessary to acquire the waveform data of target cells to be classified associated with the target cells as training data. For example, it is possible to acquire the waveform data of target cells by preparing only the target cells as a training sample and emitting structured illumination light to the cells contained in the training sample. Alternatively, waveform data indicating the morphological characteristics of target cells can be similarly acquired by fluorescent staining only the target cells and specifying the target cells by using the labeling by the fluorescent staining.

However, it is difficult to prepare target cells (or cells other than target cells) with high purity or to label these with fluorescent staining, and it may not be possible to secure the required amount of appropriate training samples in advance. In this case, it is not possible to prepare in advance a training sample containing only appropriately labeled target cells (or only cells other than target cells). For this reason, it has been difficult to create a classification model for accurately identifying target cells with conventional GC methods. In addition, in the GC method, images can be reconstructed based on the acquired waveform data. Therefore, when the target cells can be easily identified by microscopic observation or the like, it is possible to perform labeling based on the reconstructed images in principle. However, in the GC method, there is a trade-off between the length of the structured illumination for image reconstruction and the device requirements for increasing the number of cells measured per unit time. For this reason, it has been difficult to acquire waveform data and clear images in parallel for cells moving through a channel at high speed. Therefore, it has been difficult to create a classification model by labeling a large amount of waveform data acquired from cells moving through a channel based on simultaneously acquired images of the cells.

The present disclosure has been made in view of the above circumstances, and it is an object of the present disclosure to provide a data generation method, a trained model generation method, a trained model, a particle classification method, a computer program, and an information processing device that enable labeling by associating the waveform data of the particles having morphological characteristics with the characteristics of the particles.

A data generation method according to an aspect of the present disclosure, is characterized by comprising: acquiring first waveform data, which indicates morphological characteristics of a particle and is obtained by emitting light to the particle, and a photographic image obtained by photographing the particle; generating a first trained model that outputs a particle image showing morphology of a particle when waveform data is input by training using first training data including the first waveform data and the photographic image; acquiring a particle image output from the first trained model by inputting second waveform data different from the first waveform data to the first trained model; acquiring classification information indicating a classification, into which the particle is classified according to the morphological characteristics, in association with the acquired particle image; and storing data including the second waveform data and the classification information as second training data for training a second trained model that outputs classification information when waveform data is input.

In the data generation method according to an aspect of the present disclosure, it is characterized in that the acquired particle image is output, and classification information corresponding to the second waveform data is acquired by receiving a designation of a classification into which the particle is classified in association with the output particle image.

A trained model generation method according to an aspect of the present disclosure, is characterized by comprising: acquiring first waveform data, which indicates morphological characteristics of a particle and is obtained by emitting light to the particle, and a photographic image obtained by photographing the particle; generating a first trained model that outputs a particle image showing morphology of a particle when waveform data is input by training using first training data including the first waveform data and the photographic image; acquiring a particle image output from the first trained model by inputting second waveform data different from the first waveform data to the first trained model; acquiring classification information indicating a classification, into which the particle is classified according to the morphological characteristics, in association with the acquired particle image; and generating a second trained model that outputs classification information when waveform data is input by training using second training data including the second waveform data and the acquired classification information.

In the trained model generation method according to an aspect of the present disclosure, it is characterized in that the first waveform data is waveform data obtained from a particle moving at a first speed, and the second waveform data is waveform data obtained from a particle moving at a second speed different from the first speed.

In the trained model generation method according to an aspect of the present disclosure, characterized in that the waveform data is waveform data indicating a temporal change in an intensity of light emitted from a particle irradiated with light by a structured illumination or is waveform data indicating a temporal change in an intensity of light detected by structuring light from a particle irradiated with light.

A trained model according to an aspect of the present disclosure is a trained model for outputting classification information indicating a classification into which a particle is classified when waveform data indicating morphological characteristics of the particle and obtained by emitting light to the particle is input, and it is characterized in that the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

A particle classification method according to an aspect of the present disclosure, is characterized by comprising: acquiring waveform data indicating morphological characteristics of a particle and obtained by emitting light to the particle; inputting the acquired waveform data to a trained model that outputs classification information indicating a classification into which a particle is classified when waveform data is input; and classifying the particle related to the waveform data based on the classification information output from the trained model, wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

In the particle classification method according to an aspect of the present disclosure, it is characterized in that the classification information is information indicating whether or not a particle is classified into a specific classification, based on the classification information, it is determined whether or not a particle related to the waveform data is classified into the specific classification, and the particle is sorted when the particle is classified into the specific classification.

A computer program according to an aspect of the present disclosure, is characterized by causing a computer to execute processing of: acquiring first waveform data, which indicates morphological characteristics of a particle and is obtained by emitting light to the particle, and a photographic image obtained by photographing the particle; generating a first trained model that outputs a particle image showing morphology of a particle when waveform data is input by training using first training data including the first waveform data and the photographic image; acquiring a particle image output from the first trained model by inputting second waveform data different from the first waveform data to the first trained model; acquiring classification information indicating a classification, into which the particle is classified according to the morphological characteristics, in association with the acquired particle image; and storing data including the second waveform data and the classification information as second training data for training a second trained model that outputs classification information when waveform data is input.

A computer program according to an aspect of the present disclosure, is characterized by causing a computer to execute processing of: acquiring waveform data, which indicates morphological characteristics of a particle and is obtained by emitting light to the particle, and a photographic image obtained by photographing the particle; and generating a trained model that outputs a particle image showing morphology of a particle when waveform data is input by training using first training data including the acquired waveform data and the photographic image.

A computer program according to an aspect of the present disclosure, is characterized by causing a computer to execute processing of: acquiring waveform data indicating morphological characteristics of a particle and obtained by emitting light to the particle; acquiring a particle image output from a first trained model that outputs a particle image showing morphology of a particle when waveform data is input by inputting the acquired waveform data to the first trained model; acquiring classification information indicating a classification, into which the particle is classified according to the morphological characteristics, in association with the acquired particle image; and generating a second trained model that outputs classification information when waveform data is input by training using training data including the acquired waveform data and the acquired classification information.

A computer program according to an aspect of the present disclosure, is characterized by causing a computer to execute processing of: acquiring waveform data indicating morphological characteristics of a particle and obtained by emitting light to the particle; inputting the acquired waveform data to a trained model that outputs classification information indicating a classification into which a particle is classified when waveform data is input; and classifying the particle based on the classification information output from the trained model, wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

An information processing device according to an aspect of the present disclosure, is characterized by comprising: a data acquisition unit that acquires first waveform data, which indicates morphological characteristics of a particle and is obtained by emitting light to the particle, and a photographic image obtained by photographing the particle; a first trained model generation unit that generates a first trained model that outputs a particle image showing morphology of a particle when waveform data is input by training using first training data including the first waveform data and the photographic image; an image acquisition unit that inputs second waveform data different from the first waveform data to the first trained model and acquires a particle image output from the first trained model; an information acquisition unit that acquires classification information indicating a classification, into which the particle is classified according to the morphological characteristics, in association with the acquired particle image; and a data storage unit that stores data including the second waveform data and the classification information as second training data for training a second trained model that outputs classification information when waveform data is input.

An information processing device according to an aspect of the present disclosure, is characterized by comprising: a data acquisition unit that acquires first waveform data, which indicates morphological characteristics of a particle and is obtained by emitting light to the particle, and a photographic image obtained by photographing the particle; a first trained model generation unit that generates a first trained model that outputs a particle image showing morphology of a particle when waveform data is input by training using first training data including the first waveform data and the photographic image; an image acquisition unit that inputs second waveform data different from the first waveform data to the first trained model and acquires a particle image output from the first trained model; an information acquisition unit that acquires classification information indicating a classification, into which the particle is classified according to the morphological characteristics, in association with the acquired particle image; and a second trained model generation unit that generates a second trained model that outputs classification information when waveform data is input by training using second training data including the second waveform data and the classification information.

An information processing device according to an aspect of the present disclosure, is characterized by comprising: a waveform data acquisition unit that acquires waveform data indicating morphological characteristics of a particle and obtained by emitting light to the particle; and a classification unit that inputs the acquired waveform data to a trained model, which outputs classification information indicating a classification into which a particle is classified when waveform data is input, and classifies the particle based on the classification information output from the trained model, wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

In one aspect of the present disclosure, the first trained model that outputs a particle image showing the morphology of a particle when waveform data is input is trained by using the first training data including the first waveform data and the photographic image. In addition, in response to the particle image output from the first trained model to which the second waveform data has been input, classification information indicating the classification into which the particle is classified according to the morphological characteristics is acquired and associated with the second waveform data. The second training data including the second waveform data and the classification information associated with the second waveform data is generated. In this manner, it is possible to associate the waveform data of the particle with the characteristics of the particle. By using the second training data, the second trained model that outputs classification information when waveform data is input is trained.

In one aspect of the present disclosure, the particle image is output, and the designation of the classification into which the particle is classified is received. The user can recognize the morphology of the particle by observing the output particle image and determine the classification into which the particle is classified. By the user's operation, the designation of the classification into which the particle is classified is input, and classification information indicating the designated classification can be acquired.

In one aspect of the present disclosure, the first waveform data and the photographic images are acquired from particles moving at the first speed, and the second waveform data is acquired from particles moving at the second speed different from the first speed. The first trained model is generated based on the data obtained from the particles moving at the first speed, and the second trained model for acquiring classification information regarding the particles moving at the second speed is generated by using the first trained model. When the first speed is lower than the second speed, the second trained model for classifying particles moving at high speed is generated by using the first trained model generated based on the data obtained from the particles moving at low speed.

In one aspect of the present disclosure, the waveform data is waveform data indicating a temporal change in the intensity of light emitted from the particle irradiated with light by the structured illumination or waveform data indicating a temporal change in the intensity of light detected by structuring light from the particle irradiated with light. The waveform data is similar to that used in the GC method, and indicates the morphological characteristics of the particle.

In one aspect of the present disclosure, the classification information is information indicating whether or not the particle is classified into the specific classification. Based on the classification information, it can be determined whether or not the particle related to the waveform data is classified into the specific classification, and the particle can be sorted. Among the particles for which waveform data has been acquired, particles classified into the specific classification can be sorted depending on the purpose.

In an aspect of the present disclosure, even in a situation in which it is not possible to prepare a training sample containing only target particles, it is possible to create data in which waveform data is associated with the morphological characteristics of particles. The aspect of the present disclosure has excellent effects, such as being able to generate a trained model for acquiring classification information indicating the classification of particles from waveform data by using the created data as training data. The above and further objects and features will more fully be apparent from the following detailed description with accompanying drawings.

### BRIEF DESCRIPTION OF THE DRAWINGS

FIG. 1 is a conceptual diagram showing the rough procedure of a trained model generation method.

FIG. 2 is a block diagram showing a configuration example of a training apparatus for generating a trained model.

FIG. 3 is a graph showing an example of waveform data.

FIG. 4 is a block diagram showing an example of the internal configuration of an information processing device.

FIG. 5 is a conceptual diagram showing the functions of a first trained model.

FIG. 6 is a conceptual diagram showing a configuration example of the first trained model.

FIG. 7 is a conceptual diagram showing the functions of a second trained model.

FIG. 8 is a conceptual diagram showing a configuration example of the second trained model.

FIG. 9 is a flowchart showing the procedure of processing performed by an information processing device to generate trained models.

FIG. 10 is a schematic diagram showing a display example of particle images.

FIG. 11 is a schematic diagram showing an example of a method for inputting a classification designation.

FIG. 12 is a conceptual diagram showing an example of the state of classification information stored in a storage unit.

FIG. 13 is a block diagram showing a configuration example of a classification apparatus for classifying cells.

FIG. 14 is a block diagram showing an example of the internal configuration of an information processing device.

FIG. 15 is a flowchart showing the procedure of processing performed by an information processing device to classify cells.

FIG. 16 is a schematic diagram showing a display example of a classification result.

FIG. 17 is a conceptual diagram showing a configuration example of a first trained model according to a second embodiment.

FIG. 18 is a block diagram showing a configuration example of a training apparatus according to a third embodiment.

FIG. 19 is a block diagram showing a configuration example of a classification apparatus according to the third embodiment.

FIG. 20 is a diagram showing an example of a photographic image and a particle image according to the fourth embodiment.

### DETAILED DESCRIPTION

Hereinafter, the present disclosure will be specifically described with reference to the diagrams showing embodiments thereof.

### First Embodiment

In the present embodiment, cells are classified by using a GC method based on waveform data including compressed morphological information of cells obtained by emitting structured illumination light to the cells. Cells are an example of particles. First, a trained model generation method for generating a trained model necessary for cell classification processing will be described.

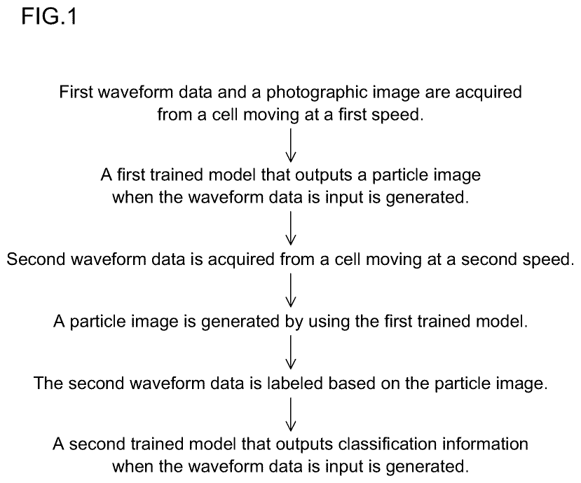

FIG. 1 is a conceptual diagram showing the rough procedure of the trained model generation method. Structured illumination light is emitted to a cell moving at a first speed to acquire first waveform data including the morphological information of the cell and a photographic image obtained by photographing the cell. The first speed is slower than the speed at which cells move during the process of classifying cells contained in a test sample. As will be described later, the waveform data indicates a temporal change in the intensity of light emitted from irradiated cell and modulated by the cell when moving cell is irradiated with structured illumination light. The waveform data includes compressed morphological information indicating the morphological characteristics of the cell, and the waveform data indicates the morphological characteristics of the cell. On the other hand, a clear photographic image can be acquired by photographing a cell moving at low speed. Then, by training using the first training data including the first waveform data and the photographic image, a first trained model that outputs a particle image showing the cell morphology when the waveform data is input is generated. The particle image is an image of particles generated based on morphological information included in the waveform data. The first trained model is trained so that a particle image equivalent to the photographic image can be obtained from the waveform data.

Then, structured illumination light is emitted to a cell moving at a second speed to acquire second waveform data including the morphological information of the cell. The second speed is higher than the first speed, and is the same as the speed at which cells move when classifying cells contained in a test sample based on waveform data. Then, a particle image is generated by using the first trained model. More specifically, the second waveform data is input to the first trained model, and the particle image output from the first trained model is acquired. Then, the second waveform data is labeled based on the acquired particle image. More specifically, the user performs labeling by checking the particle image, determining a classification into which each cell is classified according to the morphological characteristics, and associating classification information indicating the classification with the second waveform data. Then, by training using the second training data including the second waveform data and the classification information, a second trained model that outputs the classification information when the waveform data is input is generated. The second trained model is a classification model for classifying cells contained in a test sample.

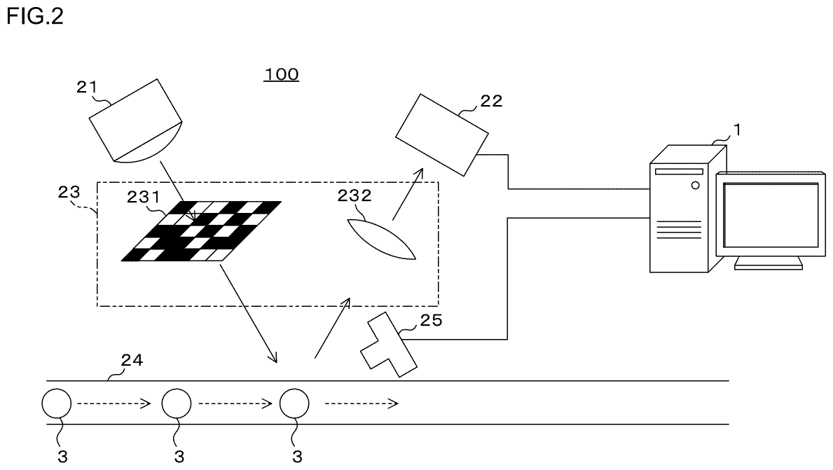

FIG. 2 is a block diagram showing a configuration example of a training apparatus 100 for generating a trained model. Waveform data for generating a trained model is acquired by the training apparatus 100. The training apparatus 100 includes a channel 24 through which cells flow. Cells 3 are dispersed in the fluid, and as the fluid flows through the channel 24, the individual cells sequentially move through the channel 24. The channel 24 has a flow rate changing mechanism (not shown) that can change the flow rate of the fluid in at least two stages. That is, the training apparatus 100 can move the cells 3 flowing through the channel 24 at at least two types of speeds. The training apparatus 100 is, for example, a flow cytometer.

The training apparatus 100 includes a light source 21 that emits illumination light to the cells 3 moving through the channel 24. The light source 21 emits white light or monochromatic light. The light source 21 is, for example, a laser light source, a semiconductor laser light source, or an LED (Light Emitting Diode) light source. The illumination light emitted from the light source 21 may be continuous light or pulsed light, but continuous light is preferable. In addition, the illumination light emitted from the light source 21 may be coherent light or incoherent light. The cells 3 irradiated with the illumination light emit light such as reflected light, scattered light, transmitted light, fluorescence, or Raman scattered light. These light components emitted from the cells 3 irradiated with the illumination light are also referred to as light modulated by the cells 3. The training apparatus 100 includes a detection unit 22 that detects light modulated by the cells 3. The detection unit 22 includes a light detection sensor such as a photomultiplier tube (PMT), a line-type PMT element, an APD (Avalanche Photo-Diode), a photodiode, or a semiconductor optical sensor. The light detection sensor included in the detection unit 22 may be a single sensor or multiple sensors. In FIG. 2, the path of light is shown by solid arrows.

The training apparatus 100 includes an optical system 23. The optical system 23 guides the light from the light source 21 to the cells 3 in the channel 24 and makes the light from the cells 3 incident on the detection unit 22. The optical system 23 includes a spatial light modulation device 231 for modulating and structuring the incident light. The light from the light source 21 is emitted to the cells 3 through the spatial light modulation device 231. The spatial light modulation device 231 is a device for modulating light by controlling the amplitude, phase, polarization, and the like of light. The spatial light modulation device 231 has, for example, a plurality of regions on a surface on which light is incident, and the incident light is modulated differently from one another in two or more of the plurality of regions. Here, the modulation of light means changing the characteristics of light, and the characteristics of light refer to, for example, any one or more of light properties such as intensity, wavelength, phase, and polarization state.

The spatial light modulation device 231 is, for example, a diffractive optical element (DOE), a spatial light modulator (SLM), or a digital micromirror device (DMD). It is noted that, when the illumination light emitted from the light source 21 is incoherent light, the spatial light modulation device 231 is a DMD.

Another example of the spatial light modulation device 231 is a film or an optical filter in which a plurality of types of regions having different light transmittances are arranged randomly or in a predetermined pattern in a one-dimensional or two-dimensional grid shape. Here, the plural types of regions having different light transmittances are arranged randomly means that a plurality of types of regions are arranged so as to be irregularly scattered. When the spatial light modulation device 231 is the above-described film or optical filter, the spatial light modulation device 231 is configured to have at least two types of regions of a region having a first light transmittance and a region having a second light transmittance different from the first light transmittance. Thus, the illumination light from the light source 21 passes through the spatial light modulation device 231 to become, for example, structured illumination light in which a plurality of types of light components having different intensities are arranged randomly or in a predetermined pattern, and the structured illumination light is emitted to the cells 3. The configuration in which the illumination light from the light source 21 is modulated by the spatial light modulation device 231 in the middle of the optical path from the light source 21 to emission to the cells 3 as described above is also referred to as a structured illumination. The illumination light modulated by the spatial light modulation device 231 becomes structured illumination light having an illumination pattern formed by a plurality of regions having different light characteristics given by the spatial light modulation device 231.

The structured illumination light is emitted to a specific region (irradiation region) in the channel 24. When the cells 3 move within the irradiation region, the cells 3 are irradiated with the structured illumination light. By moving through the irradiation region, the cells 3 are sequentially irradiated with illumination light having an illumination pattern formed by a plurality of regions having different light characteristics. For example, the cells 3 are sequentially irradiated with a plurality of types of light components having different intensities by moving through the irradiation region. The cells 3 are irradiated with structured illumination light, thereby emitting light modulated by the cells 3. The light modulated by the cells 3 is light such as reflected light, scattered light, transmitted light, fluorescence, or Raman scattered light emitted from the cells 3. While the cell 3 are irradiated with structured illumination light in the irradiation region of the channel 24, the light modulated by the cell 3 are continuously detected by the detection unit 22. The training apparatus 100 can acquire waveform data indicating a temporal change in the intensity of light detected by the detection unit 22.

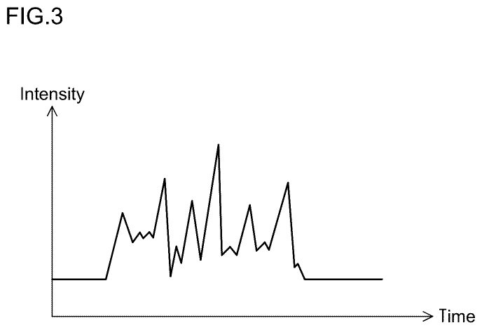

FIG. 3 is a graph showing an example of waveform data. The waveform data shown in FIG. 3 is detected by irradiating the cells 3 with structured illumination light. In FIG. 3, the horizontal axis indicates time, and the vertical axis indicates the intensity of light detected by the detection unit 22. The waveform data includes a plurality of intensity values obtained sequentially (in time series) over time. Each intensity value indicates the intensity of light. The waveform data is time-series data of an optical signal, and the optical signal is a signal indicating the intensity of light detected by the detection unit 22. The optical signal from the cell 3 obtained by using the GC method includes compressed morphological information of the cells. The temporal change in the intensity of light detected by the detection unit 22 changes depending on the morphological characteristics of the cell 3, such as its size, shape, internal structure, density distribution, or color distribution.

The waveform data indicates a temporal change in the intensity of light modulated by the cells 3. In addition, as the cells 3 move within the irradiation region in the channel 24, the illumination part of the illumination pattern by which the cells 3 are exposed changes over time. Therefore, the intensity of light from the cells 3 also changes due to changes in the intensity of the light emitted by the structured illumination. As a result, the intensity of the light detected by the detection unit 22 changes over time. The waveform data indicating the temporal change in the intensity of light modulated by the cells 3 and acquired by the configuration of the structured illumination is waveform data including compressed morphological information according to the morphological characteristics of the cells 3. Therefore, in flow cytometers using the GC method, morphologically different cells are identified by machine learning that directly uses waveform data. In addition, it is also possible to generate images of the cells 3 from waveform data acquired by the configuration of the structured illumination. It is noted that the training apparatus 100 may be configured to individually acquire waveform data for a plurality of types of modulated light components emitted from one cell 3. That is, the training apparatus 100 may be configured to detect each of a plurality of modulated light components emitted from one cell 3 (for example, detect each of fluorescence and scattered light). In this form, waveform data for each modulated light component is acquired individually.

The optical system 23 includes a lens 232. The lens 232 collects the light from the cells 3 and makes the collected light incident on the detection unit 22. It is preferable that the optical system 23 has a configuration including optical components for irradiating the cells 3 with structured illumination light from the light source 21 and making the light from the cells 3 incident on the detection unit 22, such as a mirror, a lens, and a filter, in addition to the spatial light modulation device 231 and the lens 232. Other optical components included in the optical system 23 are, for example, a mirror, a dichroic mirror, a beam splitter, a collimator, a lens (a condensing lens or an objective lens), a slit, and a bandpass filter. In FIG. 2, descriptions of optical components other than the spatial light modulation device 231 and the lens 232 are omitted.

The training apparatus 100 includes a photographing unit 25 for photographing the cells 3 moving through the channel 24. The photographing unit 25 creates a photographic image by photographing the cells 3. For example, the photographing unit 25 is a camera having a semiconductor image sensor such as a CMOS (Complementary Metal-Oxide-Semiconductor) image sensor or a CCD (Charge Coupled Device) image sensor. In addition to the light source 21, the training apparatus 100 may further include a light source (not shown) that emits light to the cells 3 so that the cells 3 are photographed by the photographing unit 25. In addition to the optical system 23, the training apparatus 100 may further include an optical system (not shown) for guiding light for photographing to the cells 3 and making the light incident on the photographing unit 25.

The training apparatus 100 includes an information processing device 1. The information processing device 1 performs information processing necessary for generating a trained model. The detection unit 22 is connected to the information processing device 1. The detection unit 22 outputs a signal in response to the intensity of the detected light. The information processing device 1 receives the signal from the detection unit 22 as waveform data. The photographing unit 25 is connected to the information processing device 1. The photographing unit 25 outputs data indicating the created photographic image to the information processing device 1, and the information processing device 1 receives the data indicating the photographic image. It is noted that the photographing unit 25 may transmit a signal to the information processing device 1 in response to photographing, and the information processing device 1 may create a photographic image in response to the signal from the photographing unit 25.

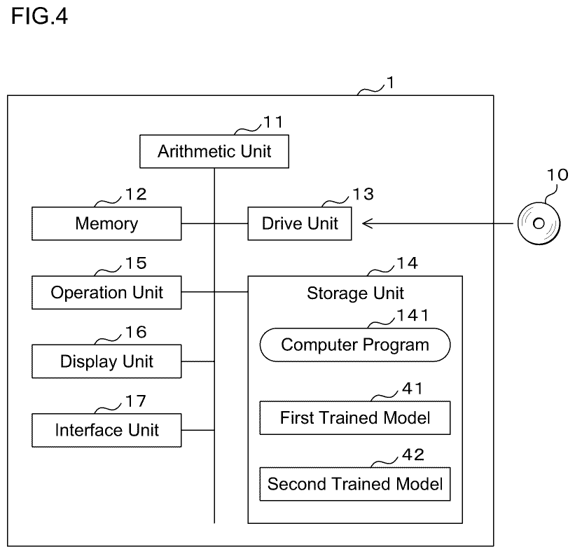

FIG. 4 is a block diagram showing an example of the internal configuration of the information processing device 1. The information processing device 1 is, for example, a computer such as a personal computer or a server device. The information processing device 1 includes an arithmetic unit 11, a memory 12, a drive unit 13, a storage unit 14, an operation unit 15, a display unit 16, and an interface unit 17. The arithmetic unit 11 is configured by using, for example, a CPU (Central Processing Unit), a GPU (Graphics Processing Unit), or a multi-core CPU. The arithmetic unit 11 may be configured by using a quantum computer. The memory 12 stores temporary data generated along with calculations. The memory 12 is, for example, a RAM (Random Access Memory). The drive unit 13 reads information from a recording medium 10 such as an optical disc or a portable memory.

The storage unit 14 is nonvolatile, and is, for example, a hard disk or a nonvolatile semiconductor memory. The operation unit 15 receives an input of information, such as text, by receiving an operation from the user. The operation unit 15 is, for example, a touch panel, a keyboard, or a pointing device. The display unit 16 displays an image. The display unit 16 is, for example, a liquid crystal display or an EL display (Electroluminescent Display). The operation unit 15 and the display unit 16 may be integrated. The interface unit 17 is connected to the detection unit 22 and the photographing unit 25. The interface unit 17 transmits and receives signals to and from the detection unit 22. In addition, the interface unit 17 transmits and receives signals to and from the photographing unit 25.

The arithmetic unit 11 causes the drive unit 13 to read a computer program 141 recorded on the recording medium 10, and stores the read computer program 141 in the storage unit 14. The arithmetic unit 11 performs processing necessary for the information processing device 1 according to the computer program 141. It is noted that the computer program 141 may be downloaded from the outside of the information processing device 1. Alternatively, the computer program 141 may be stored in the storage unit 14 in advance. In these cases, the information processing device 1 does not need to include the drive unit 13. It is noted that the information processing device 1 may be configured by a plurality of computers.

The information processing device 1 includes a first trained model 41 and a second trained model 42. The first trained model 41 and the second trained model 42 are realized by the arithmetic unit 11 executing information processing according to the computer program 141. The storage unit 14 stores data necessary for realizing the first trained model 41 and the second trained model 42. It is noted that the first trained model 41 or the second trained model 42 may be configured by hardware. The first trained model 41 or the second trained model 42 may be realized by using a quantum computer. Alternatively, the first trained model 41 or the second trained model 42 may be provided outside the information processing device 1, and the information processing device 1 may perform processing by using the external first trained model 41 or second trained model 42. For example, the first trained model 41 or the second trained model 42 may be configured on the cloud.

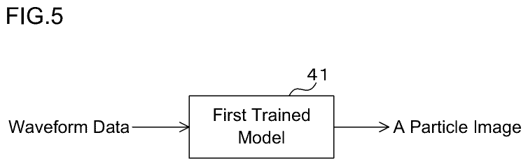

FIG. 5 is a conceptual diagram showing the functions of the first trained model 41. Waveform data obtained from each cell 3 is input to the first trained model 41. The first trained model 41 is trained so as to output a particle image showing the morphology of the cell 3 when waveform data is input.

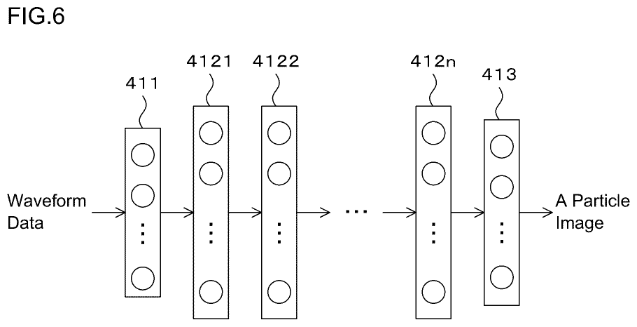

FIG. 6 is a conceptual diagram showing a configuration example of the first trained model 41. FIG. 6 shows an example in which the first trained model 41 is configured by using a fully connected neural network including an input layer 411, a plurality of intermediate layers 4121, 4122, . . . , 412n, and an output layer 413. n is the number of intermediate layers. Circles in FIG. 6 indicate nodes. The input layer 411 has a plurality of nodes to which a plurality of intensity values included in the waveform data are input.

Each of the first intermediate layer 4121, the second intermediate layer 4122, . . . , the n-th intermediate layer 412n has a plurality of nodes. Each node of the input layer 411 outputs a signal value to a plurality of nodes of the first intermediate layer 4121. Each node of the first intermediate layer 4121 receives the signal value, performs a calculation using parameters on the signal value, and outputs data of the calculation result to a plurality of nodes included in the second intermediate layer 4122. A node included in each intermediate layer receives data from a plurality of nodes in the previous intermediate layer, performs a calculation using parameters on the received data, and outputs data to nodes in the subsequent intermediate layer. The number of intermediate layers may be one.

The output layer 413 of the first trained model 41 has a plurality of nodes. Each node of the output layer 413 receives data from each node of the n-th intermediate layer 412n, performs a calculation using parameters on the received data, and outputs each pixel value included in the particle image. The pixel value indicates the brightness of each pixel forming the particle image. The particle image has a plurality of pixel values output from the output layer 413.

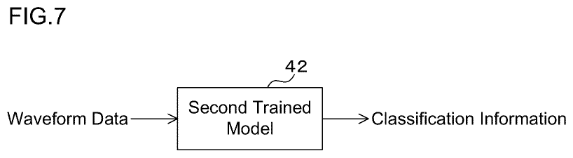

FIG. 7 is a conceptual diagram showing the functions of the second trained model 42. Waveform data obtained from one cell 3 is input to the second trained model 42. The second trained model 42 is trained so as to output classification information indicating classifications into which cells are classified when waveform data is input.

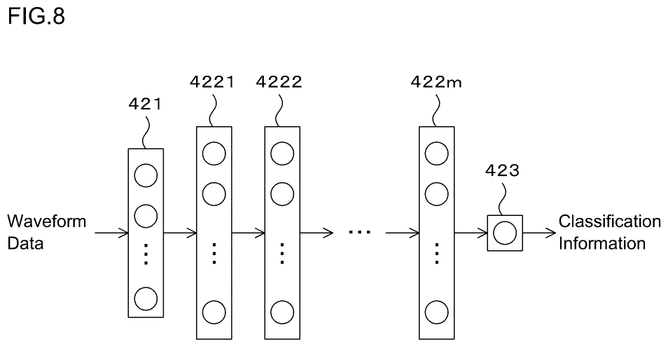

FIG. 8 is a conceptual diagram showing a configuration example of the second trained model 42. FIG. 8 shows an example in which the second trained model 42 is configured by using a fully connected neural network including an input layer 421, a plurality of intermediate layers 4221, 4222, . . . , 422m, and an output layer 423. m is the number of intermediate layers. Circles in FIG. 8 indicate nodes. The input layer 421 has a plurality of nodes to which a plurality of intensity values included in the waveform data are input. Each of the first intermediate layer 4221, the second intermediate layer 4222, . . . , the m-th intermediate layer 422m has a plurality of nodes. Each node of the input layer 421 outputs a signal value to a plurality of nodes of the first intermediate layer 4221. Each node of the first intermediate layer 4221 receives the signal value, performs a calculation using parameters on the signal value, and outputs data of the calculation result to a plurality of nodes included in the second intermediate layer 4222. A node included in each intermediate layer receives data from a plurality of nodes in the previous intermediate layer, performs a calculation using parameters on the received data, and outputs data to nodes in the subsequent intermediate layer. The number of intermediate layers may be one.

The output layer 423 of the second trained model 42 has a single node. The node of the output layer 423 receives data from each node of the m-th intermediate layer 422m, performs a calculation using parameters on the received data, and outputs classification information. For example, the classification information is a discrete numerical value, and the numerical value corresponds to the classification into which the cell 3 is classified. The output layer 423 may have a plurality of nodes corresponding to a plurality of classifications, and each node may output a probability that the cell 3 is classified into each of the plurality of classifications as classification information.

The first trained model 41 or the second trained model 42 may use a convolutional neural network (CNN), a deep neural network (DNN), or a recurrent neural network (RNN) as a neural network. The first trained model 41 may be configured by using a GAN (Generative Adversarial Network) or U-net. Alternatively, the first trained model 41 or the second trained model 42 may be a trained model other than a neural network.

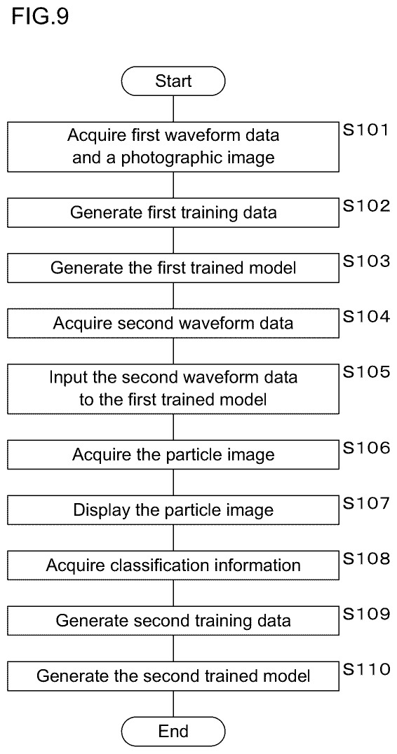

The information processing device 1 performs training of the first trained model 41 by using the first training data, creates the second training data by using the first trained model 41, and performs training of the second trained model 42 by using the second training data. FIG. 9 is a flowchart showing the procedure of processing performed by the information processing device 1 to generate trained models. Hereinafter, the step is abbreviated as S. The arithmetic unit 11 performs the following processing according to the computer program 141.

The information processing device 1 acquires first waveform data obtained from a cell 3 moving through the channel 24 and a photographic image obtained by photographing the cell 3 (S101). The cell 3 flows through the channel 24, and the cell 3 moves at a first speed. The first speed is relatively low. Structured illumination light is emitted to the cell 3 by using the light source 21 and the spatial light modulation device 231. Due to the emission of the structured illumination light, the cell 3 emits light modulated by the cell 3, such as fluorescence. The emitted light is detected by the detection unit 22 over time. The detection unit 22 outputs a signal according to the intensity of the detected light to the information processing device 1, and the information processing device 1 receives the signal from the detection unit 22 as waveform data through the interface unit 17. In S101, the arithmetic unit 11 causes the interface unit 17 to acquire a signal indicating a temporal change in the intensity of light from the detection unit 22, and stores the acquired waveform data in the storage unit 14 as first waveform data.

In addition, the photographing unit 25 creates a photographic image by photographing the cell 3, and outputs data indicating the photographic image to the information processing device 1. In S101, the information processing device 1 receives the data indicating the photographic image through the interface unit 17, and the arithmetic unit 11 stores the data indicating the photographic image in the storage unit 14. Alternatively, the photographing unit 25 transmits a signal according to photographing to the information processing device 1, the information processing device 1 receives the signal through the interface unit 17, and the arithmetic unit 11 creates a photographic image based on the received signal and stores data indicating the photographic image in the storage unit 14.

In S101, the arithmetic unit 11 stores the first waveform data and the photographic image in the storage unit 14 in association with each other. A plurality of cells 3 flow through the channel 24, and S101 is executed for each cell. That is, the arithmetic unit 11 acquires the first waveform data and the photographic image for each of the plurality of cells 3, and stores these in the storage unit 14 in association with each other. The processing of S101 corresponds to a data acquisition unit.

Then, the information processing device 1 generates first training data including the first waveform data and the photographic images for the plurality of cells 3 (S102). In S102, the arithmetic unit 11 generates first training data including a plurality of sets of first waveform data and photographic images associated with each other, and stores the first training data in the storage unit 14.

In addition, in S102, the arithmetic unit 11 generates the first training data after reducing the number of intensity values included in the first waveform data. The first waveform data is obtained from the cell 3 moving at the first speed that is a low speed. Therefore, compared with waveform data obtained from the cell 3 moving at a higher speed, the time taken for the cell 3 to move through the irradiation region is longer, and the number of intensity values included in the first waveform data is larger. Therefore, the arithmetic unit 11 reduces the number of intensity values included in the first waveform data so as to be the same as the number of intensity values included in the waveform data obtained from the cell 3 moving at the second speed that is a higher speed. In this case, the number of intensity values in the first waveform data included in the first training data is smaller than the number of intensity values included in the waveform data received by the interface unit 17.

In addition, in S102, for example, the arithmetic unit 11 may reduce the number of intensity values included in the first waveform data by down sampling the first waveform data. For example, the arithmetic unit 11 reduces the number of intensity values included in the first waveform data by calculating the moving average of the intensity values included in the first waveform data. For example, the number of intensity values included in the first waveform data in the first training data matches the number of nodes included in the input layer 411 of the first trained model 41. It is noted that the arithmetic unit 11 may generate the first waveform data with a reduced number of intensity values when acquiring the first waveform data in S101 instead of performing the processing for reducing the number of intensity values included in the first waveform data in S102.

Then, the information processing device 1 generates the first trained model 41 by performing training using the first training data (S103). In S103, the arithmetic unit 11 inputs the first waveform data included in the first training data to the first trained model 41 to perform training of the first trained model. The first trained model 41 is a model that predicts and outputs a particle image in response to the input of waveform data. The arithmetic unit 11 acquires a particle image which is reconstructed from the first waveform data and is output from the first trained model. The arithmetic unit 11 calculates an error between the photographic image associated with the first waveform data and the particle image reconstructed from the first waveform data, and adjusts the calculation parameters of the first trained model 41 so that the error is minimized. That is, the parameters are adjusted so that a particle image that is almost the same as the photographic image associated with the first waveform data is output. For example, the arithmetic unit 11 adjusts the calculation parameters of each node included in the first trained model 41 by using a backpropagation method. The arithmetic unit 11 may adjust the parameters by using a training algorithm other than the backpropagation method.

The arithmetic unit 11 adjusts the parameters of the first trained model 41 by repeating the processing using a plurality of sets of first waveform data and photographic images included in the first training data, thereby performing machine learning of the first trained model 41. When the first trained model 41 is a neural network, the adjustment of the calculation parameters of each node is repeated. The first trained model 41 is trained so that, when waveform data obtained from a cell is input, a particle image showing the morphology of the cell similar to the photographic image is output. The arithmetic unit 11 stores learned data, in which the adjusted final parameters are recorded, in the storage unit 14. In this manner, the learned first trained model 41 is generated. The processing of S103 corresponds to a first trained model generation unit.

Then, the information processing device 1 acquires second waveform data different from the first waveform data (S104). The cell 3 flows through the channel 24, and the cell 3 moves at a second speed. The second speed is higher than the first speed. The second speed is the same as a speed at which cell moves when performing cell classification processing, which will be described later. The cell 3 is irradiated with structured illumination light, and the light modulated by the cell 3 is detected by the detection unit 22. The detection unit 22 outputs a signal according to the intensity of the detected light to the information processing device 1, and the information processing device 1 receives the signal from the detection unit 22 as waveform data through the interface unit 17. In S104, the arithmetic unit 11 causes the interface unit 17 to acquire a signal indicating a temporal change in the intensity of light from the detection unit 22, and stores the acquired waveform data in the storage unit 14 as second waveform data. A plurality of cells 3 flow through the channel 24, and S104 is executed for each cell. That is, the arithmetic unit 11 acquires the second waveform data regarding each of the plurality of cells 3, and stores the plurality of pieces of second waveform data in the storage unit 14.

The information processing device 1 inputs the second waveform data to the first trained model 41 (S105). In S105, the arithmetic unit 11 inputs the second waveform data to the first trained model 41, and causes the first trained model 41 to perform the processing. In response to the input of the second waveform data, the first trained model 41 performs processing for outputting a particle image showing the morphology of each cell related to the second waveform data. The information processing device 1 acquires the particle image output from the first trained model 41 (S106). In S106, the arithmetic unit 11 stores the particle image output from the first trained model 41 in the storage unit 14 in association with the second waveform data.

S105 and S106 are executed for each of the plurality of pieces of second waveform data. That is, the arithmetic unit 11 sequentially inputs the plurality of pieces of second waveform data to the first trained model 41, and stores a plurality of particle images output from the first trained model 41 in the storage unit 14. The processing of S106 corresponds to an image acquisition unit.

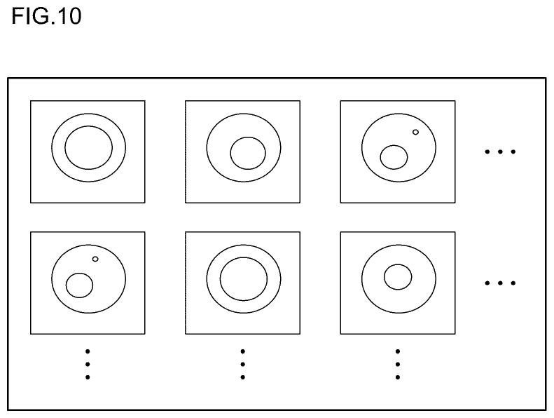

The information processing device 1 displays the particle images on the display unit 16 (S107). In S107, the arithmetic unit 11 reads the data of the particle images output from the first trained model 41 from the storage unit 14, and displays the particle images on the display unit 16 based on the data. FIG. 10 is a schematic diagram showing a display example of particle images. A plurality of particle images are displayed side by side on the screen of the display unit 16. The user can recognize the morphology of each cell 3 by observing the displayed particle images. It is noted that the plurality of particle images may not be displayed at once, but each particle image may be displayed individually.

Then, according to the displayed particle images, the information processing device 1 acquires classification information indicating classifications into which the cells 3 related to the particle images are classified (S108). The user determines a classification into which each cell 3 is classified according to the morphological characteristics of the cell 3 recognized from the displayed particle image. Here, classifying the cell 3 according to the morphological characteristics recognized by the user from the displayed particle image is also expressed as classifying a particle according to the morphological characteristics in association with the acquired particle image. In S108, the user inputs a designation of the classification into which the cell 3 is classified by operating the operation unit 15, and the arithmetic unit 11 receives the classification designation. The arithmetic unit 11 acquires classification information by generating information indicating the designated classification. Based on the classification information, the user can, for example, set as a target cell a cell included in a classification indicating specific morphological characteristics among the classifications into which the cells 3 are classified.

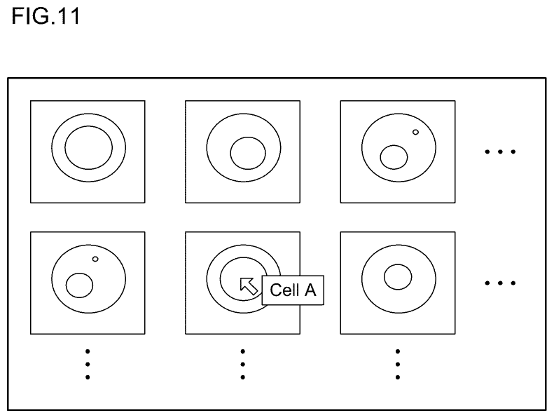

FIG. 11 is a schematic diagram showing an example of a method for inputting a classification designation. By the user's operation on the operation unit 15, one of the plurality of particle images displayed on the display unit 16 is designated with a cursor. An area for inputting the name of the classification is displayed, and the user inputs the name of the classification by operating the operation unit 15. FIG. 11 shows an example in which “Cell A” is input as the name of a classification. The arithmetic unit 11 receives a classification designation and acquires the classification information. The classification information may be acquired by using other methods. For example, a plurality of classification options may be displayed, and the user may input a classification designation by selecting one of the options.

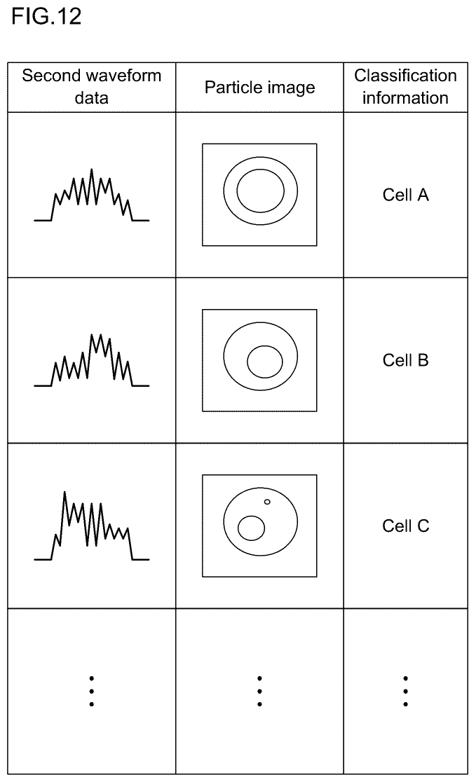

S108 is executed for each of the plurality of particle images. The user inputs a classification designation for each particle image, and the arithmetic unit 11 acquires the classification information. The arithmetic unit 11 stores classification information of the second waveform data in the storage unit 14 in association with the particle image. FIG. 12 is a conceptual diagram showing an example of the state of classification information stored in the storage unit 14. FIG. 12 shows an example in which one cell is classified into a classification “Cell A,” another cell is classified into a classification “Cell B,” and yet another cell is classified into a classification “Cell C”. The second waveform data and the particle images are stored in association with each other, and the classification information is stored in association with the particle images. Therefore, the classification information is stored in association with the second waveform data. A plurality of combinations of waveform data, particle images, and classification information are stored. The processing of S108 corresponds to an information acquisition unit.

Then, the information processing device 1 generates second training data including the second waveform data and the classification information regarding the plurality of cells 3 (S109). In S109, the arithmetic unit 11 generates second training data including a plurality of sets of second waveform data and classification information associated with each other, and stores the second training data in the storage unit 14. At this time, for example, a cell showing specific morphological characteristics is set as a target cell, and second waveform data having classification information corresponding to the target cell is labeled as Ground Truth. The processing of S109 corresponds to a data storage unit. The processing of S101 to S109 corresponds to a data generation method.

Then, the information processing device 1 generates the second trained model 42 by performing training using the second training data (S110). In S110, the arithmetic unit 11 inputs the second waveform data included in the second training data to the second trained model 42. The second trained model 42 is a model that outputs classification information when waveform data is input. Of the second training data, waveform data acquired from the cell 3 belonging to the target classification is learned as waveform data acquired from the target cell. Of the second training data, waveform data acquired from the cells 3 belonging to classifications other than the target classification is learned as waveform data acquired from cells other than the target cell. The arithmetic unit 11 calculates an error between the classification information associated with the input second waveform data and the classification information output from the second trained model 42, and adjusts the calculation parameters of the second trained model 42 so that the error is minimized. That is, the parameters are adjusted so that classification information that almost matches the classification information associated with the second waveform data is output. For example, the arithmetic unit 11 adjusts the calculation parameters of each node included in the second trained model 42 by using a backpropagation method. The arithmetic unit 11 may adjust the parameters by using a training algorithm other than the backpropagation method.

The arithmetic unit 11 adjusts the parameters of the second trained model 42 by repeating the processing using a plurality of sets of second waveform data and classification information included in the second training data, thereby performing machine learning of the second trained model 42. When the second trained model 42 is a neural network, the adjustment of the calculation parameters of each node is repeated. The second trained model 42 is a model that, when waveform data obtained from a cell is input, predicts and outputs classification information indicating a classification into which the cell is classified. The arithmetic unit 11 stores learned data, in which the adjusted final parameters are recorded, in the storage unit 14. In this manner, the learned second trained model 42 is generated. The processing of S110 corresponds to a second trained model generation unit. The generated second trained model is a classification model for classifying cells. After S110 ends, the information processing device 1 ends the process for generating trained models.

In the above description, an example is shown in which the processing of S101 to S110 are executed continuously. However, the processing of S101 to S103 and the processing of S104 to S110 may be performed separately. For example, the processing of S101 to S103 may be performed by a first training apparatus for generating the first trained model 41, and the processing of S104 to S110 may be performed by a second training apparatus for generating the second trained model 42. An information processing device included in the first training apparatus generates the first trained model 41 by performing the processing of S101 to S103. An information processing device included in the second training apparatus realizes the first trained model 41 by storing learned data including the learned parameters of the first trained model 41. The information processing device included in the second training apparatus generates the second trained model 42 by performing the processing of S104 to S110.

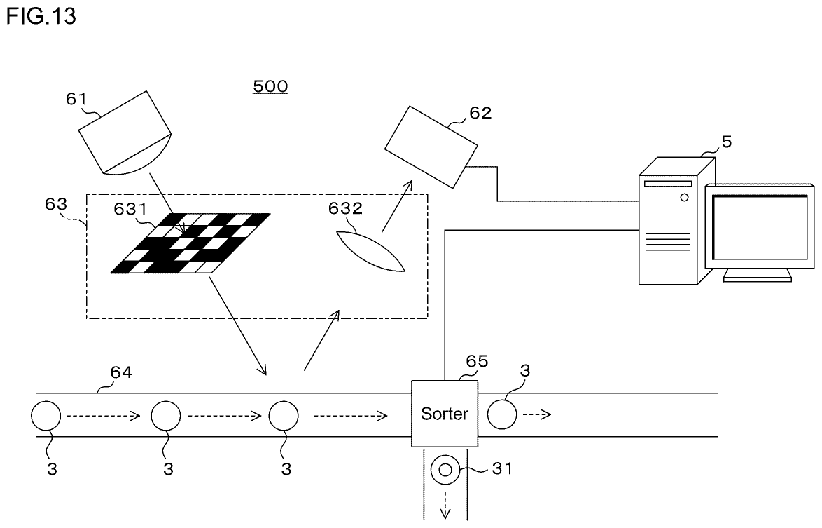

By using the learned second trained model 42, cells contained in the test sample are classified. FIG. 13 is a block diagram showing a configuration example of a classification apparatus 500 for classifying cells. The classification apparatus 500 is, for example, a flow cytometer. In the following description, a case will be described in which the classification apparatus 500 is a cell sorter that further has a function of sorting target cells from cells contained in a test sample. The classification apparatus 500 includes a channel 64 through which cells flow. The cells 3 sequentially move through the channel 64. The classification apparatus 500 includes a light source 61, a detection unit 62, and an optical system 63. The light source 61 emits white light or monochromatic light. As the light source 61, a light source similar to the light source 21 shown in FIG. 2 can be used. As the detection unit 62, a light detection sensor similar to the light detection sensor included in the detection unit 22 shown in FIG. 2 can be used. For example, the detection unit 62 includes a light detection sensor such as a photomultiplier tube, a photodiode, or a semiconductor optical sensor. In FIG. 13, the path of light is shown by solid arrows.

The optical system 63 guides the light from the light source 61 to the cells 3 in the channel 64 and makes the light from the cells 3 incident on the detection unit 62. The optical system 63 includes a spatial light modulation device 631 and a lens 632. The light from the light source 61 is emitted to the cells 3 through the spatial light modulation device 631. This forms a structured illumination. The classification apparatus 500 can acquire waveform data indicating a temporal change in the intensity of light emitted from the cells 3. The waveform data can be acquired by using, for example, the GC method, and the waveform data includes the morphological information of the cells 3. The classification apparatus 500 may be configured to individually acquire waveform data for each of a plurality of modulated light components (for example, scattered light and transmitted light) emitted from one cell 3.

It is preferable that the optical system 63 includes optical components for irradiating the cells 3 with light from the light source 21 and making the light from the cells 3 incident on the detection unit 62, such as a mirror, a lens, and a filter, in addition to the spatial light modulation device 631 and the lens 632. In FIG. 13, descriptions of optical components other than the spatial light modulation device 631 and the lens 632 are omitted. The optical system 63 can have a similar configuration to the optical system 23.

A sorter 65 is coupled with the channel 64. The sorter 65 is a mechanism for sorting a specific cell 31 from the cells 3 that have moved through the channel 64. For example, when the cell 3 that has moved through the channel 64 is the specific cell 31, the sorter 65 sorts the specific cell 31 by supplying an electric charge to the moving cell 3 and applying a voltage to the cell 3 so as to change the movement path of the cell 3. Alternatively, the sorter 65 may be configured to generate a pulse flow when the cells 3 flow to the sorter 65 and change the movement path of the cells 3 to sort the specific cell 31.

The classification apparatus 500 includes an information processing device 5. The information processing device 5 performs information processing necessary for classifying the cells 3. The detection unit 62 is connected to the information processing device 5. The detection unit 62 outputs a signal according to the intensity of the detected light, and the information processing device 5 receives the signal from the detection unit 62 as waveform data. The sorter 65 is connected to the information processing device 5 and is controlled by the information processing device 5. The sorter 65 sorts the specific cell 31 under the control of the information processing device 5.

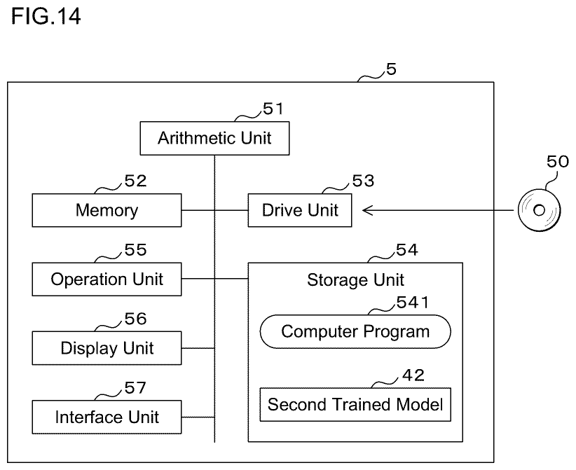

FIG. 14 is a block diagram showing an example of the internal configuration of the information processing device 5. The information processing device 5 is a computer such as a personal computer or a server device. The information processing device 5 includes an arithmetic unit 51, a memory 52, a drive unit 53, a storage unit 54, an operation unit 55, a display unit 56, and an interface unit 57. The arithmetic unit 51 is configured by using, for example, a CPU, a GPU, or a multi-core CPU. The arithmetic unit 51 may be configured by using a quantum computer. The memory 52 stores temporary data generated along with calculations. The drive unit 53 reads information from a recording medium 50 such as an optical disc.

The storage unit 54 is nonvolatile, and is, for example, a hard disk or a nonvolatile semiconductor memory. The operation unit 55 receives an input of information, such as text, by receiving an operation from the user. The operation unit 55 is, for example, a touch panel, a keyboard, or a pointing device. The display unit 56 displays an image. The display unit 56 is, for example, a liquid crystal display or an EL display. The operation unit 55 and the display unit 56 may be integrated. The interface unit 57 is connected to the detection unit 62 and the sorter 65. The interface unit 57 transmits and receives signals to and from the detection unit 62. In addition, the interface unit 57 transmits and receives signals to and from the sorter 65.

The arithmetic unit 51 causes the drive unit 53 to read a computer program 541 recorded on the recording medium 50, and stores the read computer program 541 in the storage unit 54. The arithmetic unit 51 performs processing necessary for the information processing device 5 according to the computer program 541. It is noted that the computer program 541 may be downloaded from the outside of the information processing device 5. Alternatively, the computer program 541 may be stored in the storage unit 54 in advance. In these cases, the information processing device 5 does not need to include the drive unit 53. It is noted that the information processing device 5 may be configured by a plurality of computers.

The information processing device 5 includes the second trained model 42. The second trained model 42 is realized by the arithmetic unit 51 executing information processing according to the computer program 541. The second trained model 42 is a trained model trained by the training apparatus 100. The information processing device 5 includes the second trained model 42 by storing learned data, in which the parameters of the second trained model 42 trained by the training apparatus 100 are recorded, in the storage unit 54. For example, the learned data is read from the recording medium 50 by the drive unit 53 or downloaded. It is noted that the second trained model 42 may be configured by hardware. The second trained model 42 may be realized by using a quantum computer. Alternatively, the second trained model 42 may be provided outside the information processing device 5, and the information processing device 5 may perform processing by using the external second trained model 42. For example, the second trained model 42 may be configured on the cloud.

It is noted that, in the information processing device 5, the second trained model 42 may be realized by an FPGA (Field Programmable Gate Array). The circuit of the FPGA is configured based on the parameters of the second trained model 42 trained by using the trained model generation method, and the FPGA executes the processing of the second trained model 42.

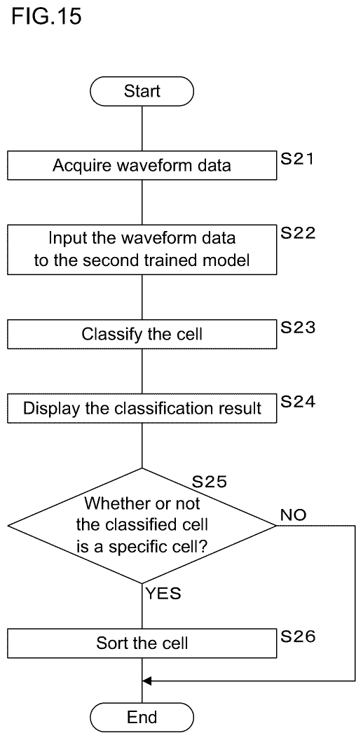

FIG. 15 is a flowchart showing the procedure of processing performed by the information processing device 5 to classify cells. The arithmetic unit 51 performs the following processing according to the computer program 541. The information processing device 5 acquires waveform data from the cells 3 moving through the channel 64 (S21). The cells 3 to be classified that are contained in the test sample flow through the channel 64, and the cells 3 move at the same speed as the second speed. The cells 3 are irradiated with structured illumination light, and the light modulated by the cells 3 is detected by the detection unit 62. The detection unit 62 outputs a signal according to the detection, and the information processing device 5 receives the signal output from the detection unit 62. In S21, the arithmetic unit 51 acquires waveform data indicating a temporal change in the intensity of light detected by the detection unit 62 based on the signal from the detection unit 62, and stores the acquired waveform data in the storage unit 54. The processing of S21 corresponds to a waveform data acquisition unit.

The information processing device 5 inputs the acquired waveform data to the second trained model 42 (S22). In S22, the arithmetic unit 51 inputs the waveform data to the second trained model 42, and causes the second trained model 42 to perform processing. The second trained model 42 performs processing for outputting classification information in response to the input of the waveform data. The information processing device 5 classifies the cells 3 based on the classification information output from the second trained model 42 (S23). In S23, the arithmetic unit 51 classifies each cell 3 into the classification indicated by the classification information. As necessary, the arithmetic unit 51 stores a classification result, in which the waveform data is associated with information indicating the classification into which the cell 3 is classified, in the storage unit 54. The processing of S23 corresponds to a classification unit.

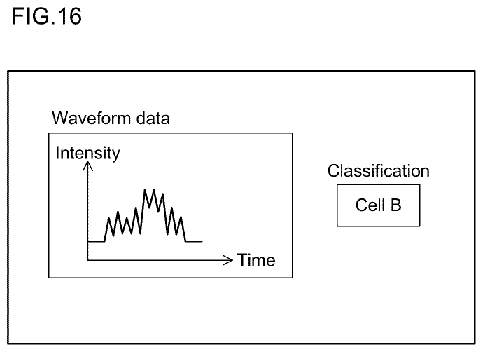

Then, the information processing device 5 displays the classification result on the display unit 56 (S24). FIG. 16 is a schematic diagram showing a display example of the classification result. In FIG. 16, as the classification result, waveform data is displayed in the form of a graph, and the classification to which the cell 3 is classified is displayed in characters. In S24, the arithmetic unit 51 reads the classification result from the storage unit 54, generates an image showing the waveform data and the classification, and displays the image on the display unit 56. It is noted that S24 may be omitted.

Then, based on the classification result, the information processing device 5 controls the sorter 65 to sort the cell 3 when the classified cell 3 is the specific cell 31. The specific cell 31 is a cell contained in the test sample, and is a target cell that needs to be sorted by the information processing device 5. The information processing device 5 determines whether or not the classified cell 3 is a specific cell (S25). In S25, the arithmetic unit 51 determines whether or not the classification of the cell 3 matches the classification of the specific cell. When the classified cell 3 is not the specific cell (S25: NO), the information processing device 5 ends the processing for classifying cells.

When the classified cell 3 is the specific cell 31 (S25: YES), the information processing device 5 sorts the specific cell 31 by using the sorter 65 (S26). In S26, the arithmetic unit 51 transmits a control signal for making the sorter 65 sort the cell from the interface unit 57 to the sorter 65. The sorter 65 sorts the specific cell 31 according to the control signal. For example, at the point in time at which the cell 3 has flowed to the sorter 65 through the channel 64, the sorter 65 sorts the specific cell 31 by supplying an electric charge to the cell 3 and applying a voltage to the cell 3 so as to change the movement path of the cell 3. After S26 ends, the information processing device 5 ends the process for classifying cells. The processing of S21 to S26 is performed for each of the cells 3 to be classified that are contained in the test sample.

As described in detail above, in the present embodiment, the first trained model 41 that outputs a particle image when waveform data is input is generated by using the first training data including the first waveform data and the photographic image. In addition, by the user who checks the particle image output from the first trained model 41 into which the second waveform data has been input, classification information indicating the classification into which each cell is classified according to the morphological characteristics is added to each piece of the second waveform data, and the second waveform data and the classification information are associated with each other. By associating the waveform data of the cell with the classification information according to the morphological characteristics of the cell, the waveform data of the cell and the characteristics of the cell are associated with each other. For example, even in a situation in which it is not possible to prepare a training sample containing only target cells, it is possible to associate waveform data with the morphological characteristics of cells. In addition, by using the second training data including the second waveform data and the classification information, the second trained model 42 that outputs classification information when waveform data is input is generated. In this manner, it is possible to create data in which the waveform data is labeled by associating the waveform data of each cell with the morphological characteristics of the cell, and the second trained model 42 for acquiring classification information from waveform data can be generated by using the created data as the second training data. By using the generated second trained model 42, each cell contained in the test sample can be classified based on the waveform data obtained from the cell. In addition, among the cells contained in the test sample for which waveform data has been acquired, a cell classified into a specific classification can be sorted as a target cell.

In addition, in the present embodiment, the first waveform data and the photographic images are acquired from particles moving at the first speed, and the second waveform data is acquired from particles moving at the second speed higher than the first speed. The second trained model 42 for classifying cells moving at high speed is generated by using the first trained model 41 generated based on the first waveform data and the photographic images obtained from cells moving at low speed. Since precise photographic images can be acquired from the cells moving at low speed, the highly accurate first trained model 41 is generated by using the precise photographic images. In addition, the second waveform data acquired from the particles moving at the second speed is labeled according to the particle image by using the generated first trained model 41, and the second trained model 42 is generated by training based on the labeling. By using the second trained model 42, it is possible to classify cells based on the morphological characteristics using waveform data, even for cells that were previously difficult to label because training samples could not be appropriately prepared. Since classification is performed based on waveform data including the morphological information of cells acquired from cells moving at high speed, it is possible to accurately classify and sort cells in a short time and at low cost.

In the first embodiment, an illustrative embodiment is shown in which, when generating the first training data, the first trained model 41 is trained so as to be applicable to cells moving at high speed by reducing the number of intensity values included in the first waveform data. Differently from this, the training apparatus 100 may be configured to increase the number of intensity values included in the second waveform data when using the first trained model 41. In this illustrative embodiment, the information processing device 1 increases the number of intensity values included in the second waveform data in S105 without reducing the number of intensity values included in the first waveform data in S102. For example, the arithmetic unit 11 increases the number of intensity values by interpolating the intensity values included in the second waveform data. In addition, the arithmetic unit 11 increases the number of intensity values included in the second waveform data so as to be the same as the number of intensity values included in the first waveform data. The information processing device 1 performs the processing of S105 by using the second waveform data with an increased number of intensity values. On the other hand, in S109, the information processing device 1 uses, as the second waveform data included in the second training data, second waveform data in which the number of intensity values is not increased. Therefore, since the second trained model 42 is trained so as to be applicable to cells moving at high speed, it is possible to classify the cells moving at high speed.

### Second Embodiment

In a second embodiment, the configuration of the first trained model 41 is different from that in the first embodiment. The configuration of the information processing device 1 and the configuration of the training apparatus 100 other than the first trained model 41 are the same as those in the first embodiment. In addition, the configuration of the classification apparatus 500 is the same as that in the first embodiment.

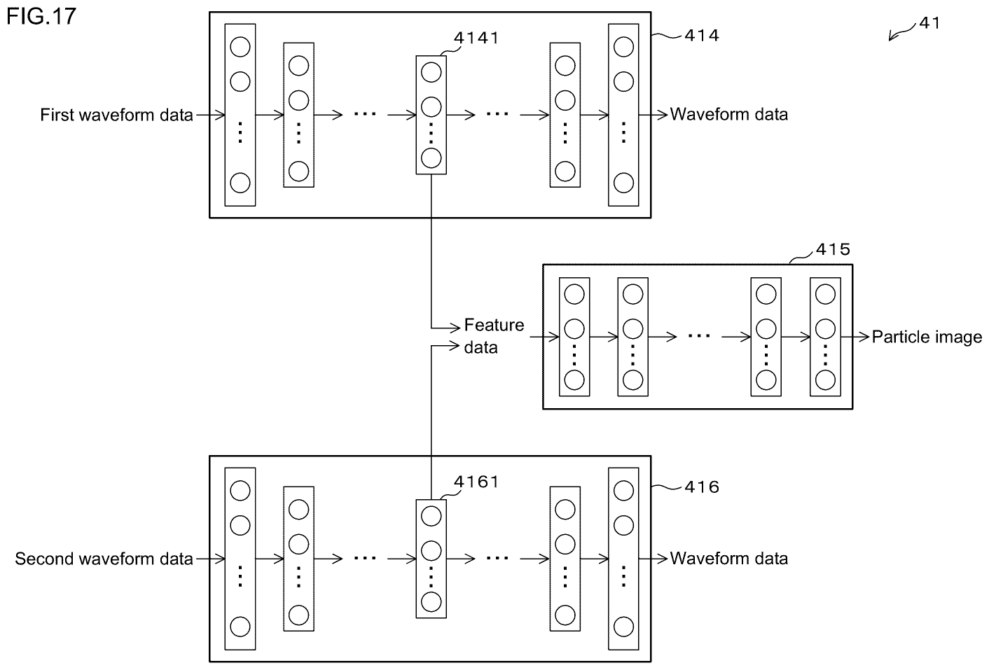

FIG. 17 is a conceptual diagram showing a configuration example of the first trained model 41 according to the second embodiment. The first trained model 41 includes an autoencoder 414, an image reconstruction part 415, and an autoencoder 416. The autoencoder 414 receives first waveform data as its input and outputs waveform data. For example, the number of nodes included in the input layer of the autoencoder 414 is the same as the number of intensity values included in the first waveform data. The autoencoder 414 is trained so that the input first waveform data and the output waveform data are the same. The autoencoder 414 includes an embedded layer 4141. The number of nodes included in the embedded layer 4141 is smaller than the number of nodes included in the input layer and the number of nodes included in the output layer. The embedded layer 4141 may be an intermediate layer, a convolutional layer, or a pooling layer. The embedded layer 4141 outputs feature data. The feature data is a reduced-dimensional feature representation of the first waveform data. The feature data includes a plurality of elements, and the number of elements is smaller than the number of intensity values included in the first waveform data.

The autoencoder 416 receives second waveform data as its input and outputs waveform data. For example, the number of nodes included in the input layer of the autoencoder 416 is the same as the number of intensity values included in the second waveform data. The autoencoder 416 is trained so that the input second waveform data and the output waveform data are the same. The autoencoder 416 includes an embedded layer 4161, and the embedded layer 4161 outputs feature data. The feature data is a reduced-dimensional feature representation of the second waveform data. The feature data includes a plurality of elements, and the number of elements is equal to or less than the number of intensity values included in the second waveform data. The embedded layer 4141 and the embedded layer 4161 are configured so that the number of elements in the feature data output from the embedded layer 4141 is the same as the number of elements in the feature data output from the embedded layer 4161.

The image reconstruction part 415 is a neural network. The feature data output from the embedded layer 4141 or the embedded layer 4161 is input to the image reconstruction part 415. The image reconstruction part 415 outputs a particle image when the feature data is input.

In S103, the information processing device 1 trains the autoencoder 414, and then trains the image reconstruction part 415. The arithmetic unit 11 inputs the first waveform data to the autoencoder 414. The autoencoder 414 outputs waveform data. The arithmetic unit 11 calculates an error between the input first waveform data and the output waveform data, and adjusts the calculation parameters of the autoencoder 414 so that the error is minimized. The arithmetic unit 11 adjusts the parameters by repeating the processing using a plurality of pieces of first waveform data included in the first training data, thereby performing machine learning of the autoencoder 414. The arithmetic unit 11 stores learned data, in which the adjusted final parameters are recorded, in the storage unit 14.

In addition, the arithmetic unit 11 inputs the first waveform data to the autoencoder 414. The embedded layer 4141 included in the autoencoder 414 outputs feature data. The arithmetic unit 11 sequentially inputs a plurality of pieces of first waveform data included in the first training data to the autoencoder 414, and a plurality of pieces of feature data are sequentially output from the embedded layer 4141.

Then, the arithmetic unit 11 inputs the feature data to the image reconstruction part 415. The image reconstruction part 415 outputs a particle image. The arithmetic unit 11 calculates an error between the photographic image associated with the first waveform data and the output particle image, and adjusts the calculation parameters of the image reconstruction part 415 so that the error is minimized. That is, the parameters are adjusted so that a particle image that is almost the same as the photographic image associated with the first waveform data is output. The arithmetic unit 11 adjusts the parameters by repeating the processing using a plurality of pieces of feature data, thereby performing machine learning of the image reconstruction part 415. The arithmetic unit 11 stores learned data, in which the adjusted final parameters are recorded, in the storage unit 14. In this manner, the autoencoder 414 and the image reconstruction part 415 that have been trained are generated.

In S105, the information processing device 1 trains the autoencoder 416, and then performs processing for inputting feature data to the image reconstruction part 415. The arithmetic unit 11 inputs the second waveform data to the autoencoder 416. The autoencoder 416 outputs waveform data. The arithmetic unit 11 calculates an error between the input second waveform data and the output waveform data, and adjusts the calculation parameters of the autoencoder 416 so that the error is minimized. The arithmetic unit 11 adjusts the parameters by repeating the processing using a plurality of pieces of second waveform data included in the second training data, thereby performing machine learning of the autoencoder 416. The arithmetic unit 11 stores learned data, in which the adjusted final parameters are recorded, in the storage unit 14.

Then, the arithmetic unit 11 inputs the second waveform data to the autoencoder 416. The embedded layer 4161 included in the autoencoder 416 outputs feature data. Then, the arithmetic unit 11 inputs the feature data to the image reconstruction part 415. In response to the input of the feature data, the image reconstruction part 415 outputs a particle image showing the morphology of each cell related to the second waveform data. The arithmetic unit 11 sequentially inputs a plurality of pieces of second waveform data included in the second training data to the autoencoder 416, the embedded layer 4161 sequentially outputs a plurality of pieces of feature data, the arithmetic unit 11 sequentially inputs the plurality of pieces of feature data to the image reconstruction part 415, and the image reconstruction part 415 sequentially outputs a plurality of particle images. In S106, the arithmetic unit 11 acquires the particle images output from the image reconstruction part 415, and stores the particle images output from the image reconstruction part 415 in the storage unit 14 in association with the second waveform data.

Also in the second embodiment, by associating the waveform data of the cell with the classification information according to the morphological characteristics of the cell, it is possible to associate the waveform data of the cell with the characteristics of the cell. In addition, it is possible to generate the second trained model 42 for acquiring classification information from waveform data. By using the generated second trained model 42, it is possible to classify cells based on waveform data obtained from the cells.

### Third Embodiment

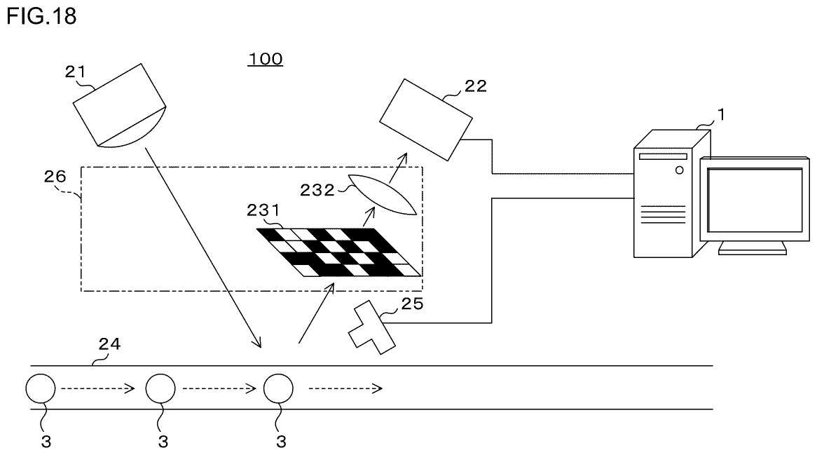

FIG. 18 is a block diagram showing a configuration example of a training apparatus 100 according to a third embodiment. In the third embodiment, the configuration of an optical system 26 is different from that in the first embodiment shown in FIG. 2. The configuration of parts other than the optical system 26 is the same as that in the first or second embodiment. The illumination light from the light source 21 is emitted to the cells 3 without passing through the spatial light modulation device 231. The light modulated by the cells 3 passes through the spatial light modulation device 231 and is condensed by the lens 232 to be incident on the detection unit 22. The detection unit 22 detects light that is structured due to the light from the cells 3 passing through the spatial light modulation device 231. The configuration in which the light from the cell 3 is modulated by the spatial light modulation device 231 in the middle of the optical path from the cell 3 to the detection unit 22 as described above is also referred to as structured detection. The intensity of the light detected by the detection unit 22 changes over time. As the cell 3 moves through the channel 24, the intensity of light from the cell 3 detected through the spatial light modulation device 231 changes over time. The waveform data indicating the temporal change in the intensity of light from the cell 3 detected by the detection unit 22 due to the configuration of the structured detection includes compressed morphological information of the cell 3, and changes according to the morphological characteristics of the cell 3.

Also in the third embodiment, the training apparatus 100 can acquire waveform data indicating a temporal change in light emitted from the cells 3. Similar to the first or second embodiment, also in the third embodiment, the waveform data indicates the morphological characteristics of the cells 3. The optical system 26 includes optical components other than the spatial light modulation device 231 and the lens 232. Other optical components included in the optical system 26 are, for example, a mirror, a lens, and a filter. In FIG. 18, descriptions of optical components other than the spatial light modulation device 231 and the lens 232 are omitted. In addition, in the structured detection, as the spatial light modulation device 231, optical components that can be used in the structured illumination described in the first or second embodiment can be similarly used. In the training apparatus 100 according to the third embodiment, for example, a film or an optical filter in which a plurality of types of regions having different light transmittances are arranged randomly or in a predetermined pattern in a one-dimensional or two-dimensional grid shape can be used as the spatial light modulation device 231. In addition, in the third embodiment, the information processing device 1 generates the second trained model 42 by performing the processing of S101 to S110, as in the first or second embodiment.

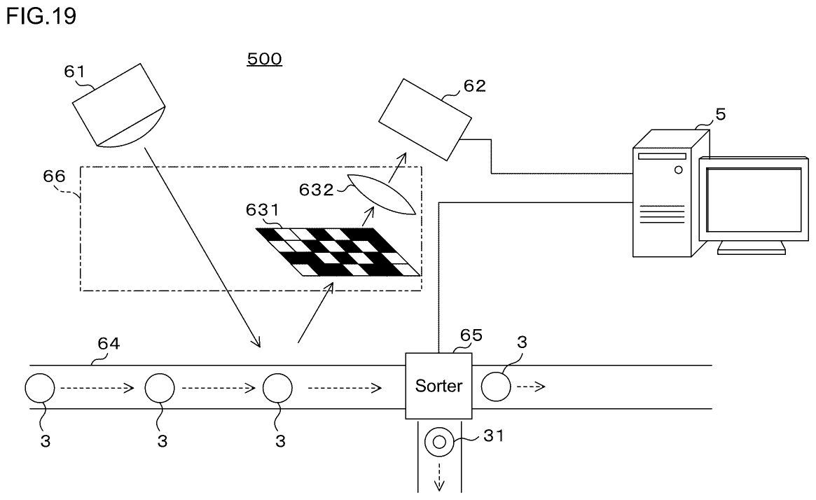

FIG. 19 is a block diagram showing a configuration example of a classification apparatus 500 according to the third embodiment. In the third embodiment, the configuration of an optical system 66 is different from that in the first embodiment shown in FIG. 13. The configuration of parts other than the optical system 66 is the same as in the first or second embodiment. The light from the light source 61 is emitted to the cells 3 without passing through the spatial light modulation device 631. The light modulated by the cells 3 passes through the spatial light modulation device 631 and is condensed by the lens 632 to be incident on the detection unit 62. The detection unit 62 detects light that is structured due to the light from the cells 3 passing through the spatial light modulation device 631. As the cell 3 moves through the channel 64, the intensity of light from the cell 3 detected by the detection unit 62 through the spatial light modulation device 631 changes over time. The waveform data indicating a temporal change in the intensity of light from the cell 3 detected due to the configuration of the structured detection changes according to the morphological characteristics of the cell 3.

Also in the third embodiment, the classification apparatus 500 can acquire waveform data indicating a temporal change in light emitted from the cells 3. Similar to the first or second embodiment, the waveform data indicates the morphological characteristics of the cells 3. The configuration of the optical system 66 is similar to that of the optical system 26, and includes optical components other than the spatial light modulation device 631 and the lens 632. In FIG. 19, descriptions of optical components other than the spatial light modulation device 631 and the lens 632 are omitted. Also in the third embodiment, the information processing device 5 performs cell sorting by performing the processing of S21 to S26, as in the first or second embodiment. In addition, one of the training apparatus 100 and the classification apparatus 500 may have the same configuration as in the first or second embodiment.

Also in the third embodiment, by associating the waveform data of the cell with the classification information according to the morphological characteristics of the cell, it is possible to associate the waveform data of the cell with the characteristics of the cell. In addition, it is possible to generate the second trained model 42 for acquiring classification information from waveform data. By using the generated second trained model 42, it is possible to classify cells contained in the test sample based on waveform data obtained from the cells. In addition, among the cells 3 contained in the test sample for which waveform data has been acquired, the cell 31 classified into a specific classification can be sorted as a target cell.

In the first to third embodiments described above, an illustrative embodiment is shown in which the classification apparatus 500 includes the sorter 65 to sort cells. However, the classification apparatus 500 may not include the sorter 65. In this illustrative embodiment, the information processing device 5 omits the processing of S25 and S26. In the first to third embodiments, an illustrative embodiment is shown in which the first speed is lower than the second speed. However, the first speed may be higher than the second speed. Alternatively, the first speed and the second speed may be the same. In the first to third embodiments, an illustrative embodiment is shown in which the training apparatus 100 and the classification apparatus 500 are different. However, the training apparatus 100 and the classification apparatus 500 may be partially or entirely the same.

In the first to third embodiments, an example is shown in which particles are cells. However, in the trained model generation method and the particle classification method, particles other than cells may be handled. Particles are not limited to biological particles. For example, particles targeted in the trained model generation method and the particle classification method may be microorganisms, such as bacteria, yeast, or plankton, and fine particles, such as spheroids (cell clusters), tissues within organisms, organs within organisms, beads (cell counting beads for flow cytometry), mock cells, pollen, microplastics, or other particulate matter.

### Fourth Embodiment

In a fourth embodiment, an example is shown in which a first trained model is created by using the training apparatus 100 and a particle image is generated. In the fourth embodiment, calibration beads were used as particles. The calibration beads used are SPHERO™ Fluorescent Yellow Particles manufactured by Spherotech, Inc. (concentration: 1.0% w/v, particle size: 10.6 μm, catalog number: FP-10052-2). Hereinafter, the calibration beads will be simply referred to as beads.

The outline of the configuration of the training apparatus 100 used is the same as that in the first embodiment. The light source 21 is a laser light source that emits laser light with a wavelength of 488 nm as illumination light. The spatial light modulation device 231 is a DOE. The detection unit 22 is a PMT. The wavelength of the light detected by the detection unit 22 was 535 nm. The photographing unit 25 is a camera having a CMOS image sensor. The flow rate in the channel 24 was 100 μL/min.

The illumination light from the light source 21 was structured by the spatial light modulation device 231, the structured illumination light was emitted to the beads moving through the channel 24, and the fluorescence emitted from the beads was detected by the detection unit 22. First waveform data indicating a temporal change in the intensity of light detected by the detection unit 22 was acquired by the information processing device 1. In addition, the information processing device 1 acquired photographic images of the beads by using the photographing unit 25. 15402 sets of first waveform data and photographic images associated with each other were created. Of the 15402 sets, 11551 sets were used as the first training data, and the remaining sets were used as evaluation data. As the first trained model 41, a DNN (Deep Neural Network) was used. The first trained model 41 that outputs a particle image when waveform data is input was created by machine learning using the first training data including a plurality of sets of first waveform data and photographic images associated with each other.

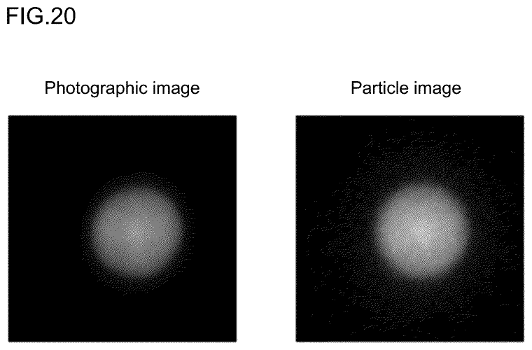

FIG. 20 is a diagram showing an example of a photographic image and a particle image according to the fourth embodiment. FIG. 20 shows a photographic image obtained by photographing a bead flowing through the channel 24 and a particle image output from the first trained model 41 to which the first waveform data acquired at the same time is input. It can be seen that the position of the bead shown in the photographic image matches the position of the bead shown in the particle image and the particle image output from the first trained model 41 to which the waveform data is input reproduces the shape of the bead.

The present invention is not limited to the content of the above-described embodiments, and various changes can be made within the scope of the claims. That is, embodiments obtained by combining technical means appropriately changed within the scope of the claims are also included in the technical scope of the present invention.

### Note 1

A non-transitory recording medium recording a computer program causing a computer to execute processing of:
acquiring first waveform data, which indicates morphological characteristics of a particle and is obtained by emitting light to the particle, and a photographic image obtained by photographing the particle;
generating a first trained model that outputs a particle image showing morphology of a particle when waveform data is input by training using first training data including the first waveform data and the photographic image;
acquiring a particle image output from the first trained model by inputting second waveform data different from the first waveform data to the first trained model;
acquiring classification information indicating a classification, into which the particle is classified according to the morphological characteristics, in association with the acquired particle image; and
storing data including the second waveform data and the classification information as second training data for training a second trained model that outputs classification information when waveform data is input.

### Note 2

A non-transitory recording medium recording a computer program causing a computer to execute processing of:
acquiring waveform data, which indicates morphological characteristics of a particle and is obtained by emitting light to the particle, and a photographic image obtained by photographing the particle; and
generating a trained model that outputs a particle image showing morphology of a particle when waveform data is input by training using first training data including the acquired waveform data and the photographic image.

### Note 3

A non-transitory recording medium recording a computer program causing a computer to execute processing of:
acquiring waveform data indicating morphological characteristics of a particle and obtained by emitting light to the particle;
acquiring a particle image output from a first trained model that outputs a particle image showing morphology of a particle when waveform data is input by inputting the acquired waveform data to the first trained model;
acquiring classification information indicating a classification, into which the particle is classified according to the morphological characteristics, in association with the acquired particle image; and
generating a second trained model that outputs classification information when waveform data is input by training using training data including the acquired waveform data and the acquired classification information.

### Note 4

A non-transitory recording medium recording a computer program causing a computer to execute processing of:
acquiring waveform data indicating morphological characteristics of a particle and obtained by emitting light to the particle;
inputting the acquired waveform data to a trained model that outputs classification information indicating a classification into which a particle is classified when waveform data is input; and
classifying the particle based on the classification information output from the trained model,
wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

### Note 5

An information processing device, comprising:
a processor; and
a memory, wherein the processor is operable to:
acquire first waveform data, which indicates morphological characteristics of a particle and is obtained by emitting light to the particle, and a photographic image obtained by photographing the particle;
generate a first trained model that outputs a particle image showing morphology of a particle when waveform data is input by training using first training data including the first waveform data and the photographic image;
input second waveform data different from the first waveform data to the first trained model and acquire a particle image output from the first trained model;
acquire classification information indicating a classification, into which the particle is classified according to the morphological characteristics, in association with the acquired particle image; and
store data including the second waveform data and the classification information as second training data for training a second trained model that outputs classification information when waveform data is input.

### Note 6

An information processing device, comprising:
a processor; and
a memory, wherein the processor is operable to:
acquire first waveform data, which indicates morphological characteristics of a particle and is obtained by emitting light to the particle, and a photographic image obtained by photographing the particle;
generate a first trained model that outputs a particle image showing morphology of a particle when waveform data is input by training using first training data including the first waveform data and the photographic image;
input second waveform data different from the first waveform data to the first trained model and acquire a particle image output from the first trained model;
acquire classification information indicating a classification, into which the particle is classified according to the morphological characteristics, in association with the acquired particle image; and
generate a second trained model that outputs classification information when waveform data is input by training using second training data including the second waveform data and the classification information.

### Note 7

An information processing device, comprising:
a processor; and
a memory, wherein the processor is operable to:
acquire waveform data indicating morphological characteristics of a particle and obtained by emitting light to the particle; and
input the acquired waveform data to a trained model, which outputs classification information indicating a classification into which a particle is classified when waveform data is input, and classify the particle based on the classification information output from the trained model,
wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

It is to be noted that, unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-15. (canceled)

16. A data generation method, comprising:
acquiring first waveform data, which indicates morphological characteristics of a particle and is obtained by emitting light to the particle, and a photographic image obtained by photographing the particle;
generating a first trained model that outputs a particle image showing morphology of a particle when waveform data is input by training using first training data including the first waveform data and the photographic image;
acquiring a particle image output from the first trained model by inputting second waveform data different from the first waveform data to the first trained model;
acquiring classification information indicating a classification, into which the particle is classified according to the morphological characteristics, in association with the acquired particle image; and
storing data including the second waveform data and the classification information as second training data for training a second trained model that outputs classification information when waveform data is input.

17. The data generation method according to claim 16,
wherein the acquired particle image is output, and
classification information corresponding to the second waveform data is acquired by receiving a designation of a classification into which the particle is classified in association with the output particle image.

18. A trained model generation method, comprising:
acquiring first waveform data, which indicates morphological characteristics of a particle and is obtained by emitting light to the particle, and a photographic image obtained by photographing the particle;
generating a first trained model that outputs a particle image showing morphology of a particle when waveform data is input by training using first training data including the first waveform data and the photographic image;
acquiring a particle image output from the first trained model by inputting second waveform data different from the first waveform data to the first trained model;
acquiring classification information indicating a classification, into which the particle is classified according to the morphological characteristics, in association with the acquired particle image; and
generating a second trained model that outputs classification information when waveform data is input by training using second training data including the second waveform data and the acquired classification information.

19. The trained model generation method according to claim 18,
wherein the first waveform data is waveform data obtained from a particle moving at a first speed, and
the second waveform data is waveform data obtained from a particle moving at a second speed different from the first speed.

20. The trained model generation method according to claim 18,
wherein the waveform data is waveform data indicating a temporal change in an intensity of light emitted from a particle irradiated with light by a structured illumination or is waveform data indicating a temporal change in an intensity of light detected by structuring light from a particle irradiated with light.

21. A particle classification method, comprising:
acquiring waveform data indicating morphological characteristics of a particle and obtained by emitting light to the particle;
inputting the acquired waveform data to a trained model that outputs classification information indicating a classification into which a particle is classified when waveform data is input; and
classifying the particle related to the waveform data based on the classification information output from the trained model,
wherein the trained model is generated by inputting second waveform data to another trained model that outputs a particle image showing morphology of a particle when waveform data is input and is trained by using first training data including first waveform data and photographic images of particles, acquiring classification information indicating a classification into which a particle is classified in association with the particle image output from the another trained model, and performing training using second training data including the second waveform data and the classification information.

22. The particle classification method according to claim 21,
wherein the classification information is information indicating whether or not a particle is classified into a specific classification,
based on the classification information, it is determined whether or not a particle related to the waveform data is classified into the specific classification, and
the particle is sorted when the particle is classified into the specific classification.
